(19) United States
(12) Patent Application Publication
(10) Pub. No.: US 2021/0231092 A1
(43) Pub. Date: Jul. 29, 2021

(54) IGNITION TIMING CONTROLLER, IGNITION TIMING CONTROL METHOD, AND IGNITION TIMING CONTROL SYSTEM FOR INTERNAL COMBUSTION ENGINE

(71) Applicant: TOYOTA JIDOSHA KABUSHIKI KAISHA, Toyota-shi (JP)

(72) Inventors: Yosuke HASHIMOTO, Nagakute-shi (JP); Akihiro KATAYAMA, Toyota-shi (JP); Yuta OSHIRO, Nagoya-shi (JP); Kazuki SUGIE, Toyota-shi (JP); Naoya OKA, Nagakute-shi (JP)

(73) Assignee: TOYOTA JIDOSHA KABUSHIKI KAISHA, Toyota-shi (JP)

(21) Appl. No.: 17/137,506

(22) Filed: Dec. 30, 2020

(30) Foreign Application Priority Data
Jan. 29, 2020 (JP) 2020-012549

(51) Int. Cl. F02P 5/15

(52) U.S. Cl. CPC F02P 5/1502

(57) ABSTRACT

A CPU mounted on a vehicle obtains positional data by the GPS. Next, the CPU identifies an octane number, which is a parameter related to combustion of fuel, on the basis of the positional data corresponding to the position of the vehicle and the date and time at which the positional data was obtained. Then, the CPU calculates a correction amount on the basis of the identified parameter. The CPU assigns, to ignition timing, a value calculated on the basis of the correction amount. The CPU controls an ignition device so that the ignition device generates spark discharge at the calculated ignition timing.

### BACKGROUND

### 1. Field

The present disclosure relates to an ignition timing controller, an ignition timing control method, and an ignition timing control system for an internal combustion engine.

### 2. Description of Related Art

Japanese Laid-Open Patent Publication No. 2010-270686 discloses an ignition timing controller for an internal combustion engine that calculates ignition timing such that the ignition timing is maximally advanced without causing knocking to occur. The ignition timing is calculated by correcting base ignition timing with a feedback term based on an output value of a knocking sensor.

The combustion state of an internal combustion engine is affected by various parameters. Some of such parameters vary considerably from one region to another. For example, the property of fuel can vary depending on the region. The ignition timing controller disclosed in Japanese Laid-Open Patent Publication No. 2010-270686 gives no consideration whatsoever to regional differences.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first general aspect, an ignition timing controller for an internal combustion engine includes an execution device and a memory device. The memory device is configured to store specific parameters related to combustion of a fuel in association with positional information. The execution device is configured to execute: a positional information obtaining process that obtains positional information of a vehicle, an identifying process that identifies, among the specific parameters stored in the memory device, a specific parameter that corresponds to the obtained positional information, and an operation process that controls an ignition device of the internal combustion engine of the vehicle on a basis of the specific parameter identified by the identifying process.

In a second general aspect, an ignition timing controller for an internal combustion engine includes an execution device and a memory device. The memory device is configured to store specific parameters related to combustion of a fuel in association with positional information. The execution device includes circuitry. The circuitry is configured to execute: a positional information obtaining process that obtains positional information of a vehicle, an identifying process that identifies, among the specific parameters stored in the memory device, a specific parameter that corresponds to the obtained positional information, and an operation process that controls an ignition device of the internal combustion engine of the vehicle on a basis of the specific parameter identified by the identifying process.

In a third general aspect, an ignition timing control method for an internal combustion engine includes: storing specific parameters related to combustion of a fuel in association with positional information; obtaining positional information of a vehicle; identifying, among the specific parameters stored in the memory device, a specific parameter that corresponds to the obtained positional information; and controlling an ignition device of the internal combustion engine of the vehicle on a basis of the identified specific parameter.

In a fourth general aspect, an ignition timing control system for an internal combustion engine includes an in-vehicle device mounted on a vehicle and out-of-vehicle device that is provided outside the vehicle. The out-of-vehicle device includes a memory device and an out-of-vehicle execution device. The memory device is configured to store specific parameters related to combustion of a fuel in association with positional information. The in-vehicle device is configured to execute: a positional information obtaining process that obtains positional information of the vehicle, and a first transmitting process that transmits a signal indicating the positional information obtained by the positional information obtaining process. The out-of-vehicle execution device is configured to execute: a first receiving process that receives the signal indicating the positional information transmitted by the first transmitting process, an identifying process that identifies, among the specific parameters stored in the memory device, a specific parameter that corresponds to the positional information received by the first receiving process, and a second transmitting process that transmits a signal indicating the specific parameter identified by the identifying process. The in-vehicle device is configured to further execute: a second receiving process that receives a signal indicating the specific parameter transmitted by the second transmitting process, and an operation process that performs an ignition operation of an ignition device of the internal combustion engine of the vehicle on a basis of the specific parameter received by the second receiving process.

Other features and aspects will be apparent from the following detailed description, the drawings, and the claims.

### BRIEF DESCRIPTION OF THE DRAWINGS

FIG. 1 is a diagram showing an internal combustion engine and a controller according to a first embodiment.

FIG. 2 is a diagram showing mapping data including specific parameters.

FIG. 3 is a flowchart showing a procedure of processes executed by the controller.

FIG. 4 is a diagram showing an ignition timing control system for an internal combustion engine according to a second embodiment.

FIGS. 5A and 5B are flowcharts showing a procedure of processes executed by the ignition timing control system for an internal combustion engine.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### First Embodiment

A first embodiment will now be described with reference to the drawings.

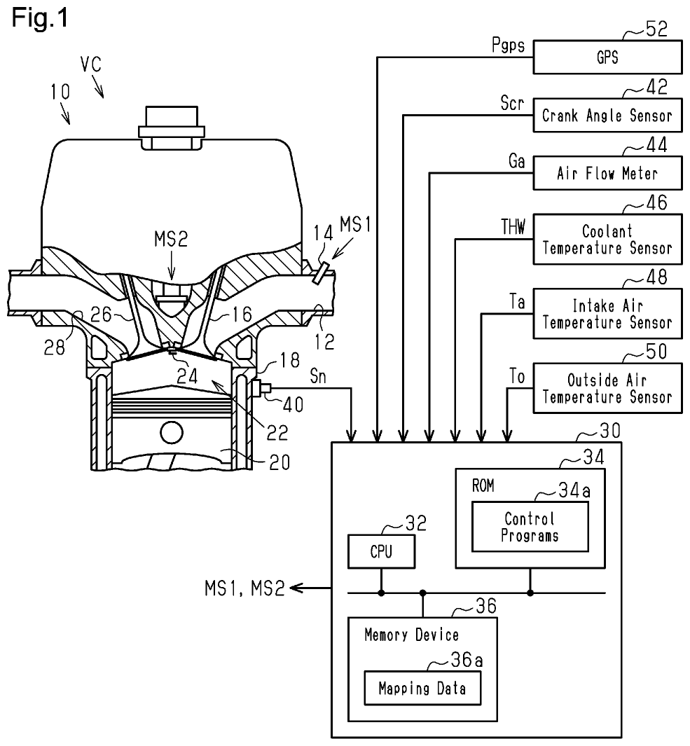

As shown in FIG. 1, an internal combustion engine 10 is mounted on a vehicle VC. The internal combustion engine 10 includes an intake passage 12, in which a fuel injection valve 14 is provided. The internal combustion engine 10 includes a combustion chamber 22, which is defined by a cylinder 18 and a piston 20. Air drawn into the intake passage 12 and fuel injected from the fuel injection valve 14 flow into the combustion chamber 22 when an intake valve 16 is opened. The mixture of air and fuel is burned in the combustion chamber 22 by spark discharge of an ignition device 24. The burned air-fuel mixture is discharged to an exhaust passage 28 as exhaust gas when an exhaust valve 26 is opened. The fuel injected by the fuel injection valve 14 is gasoline.

A controller 30 controls the internal combustion engine 10. The controller 30 operates operated units of the internal combustion engine 10 such as the fuel injection valve 14 and the ignition device 24, thereby controlling the torque and the ratios of exhaust components, which are controlled variables of the internal combustion engine 10. To control the controlled variables, the controller 30 refers to an output signal Sn of a knocking sensor 40, an output signal Scr of a crank angle sensor 42, and an intake air amount Ga detected by an air flow meter 44. Also, the controller 30 refers to a coolant temperature THW, which is the temperature of coolant of the internal combustion engine 10 detected by a coolant temperature sensor 46, an intake air temperature Ta detected by an intake air temperature sensor 48, and an outside air temperature To detected by an outside air temperature sensor 50. Further, the controller 30 refers to positional data Pgps obtained by a global positioning system (GPS 52).

The controller 30 includes a CPU 32 and a ROM 34. The controller 30 controls the above controlled variables by causing the CPU 32 to repeatedly execute programs stored in the ROM 34 at predetermined intervals.

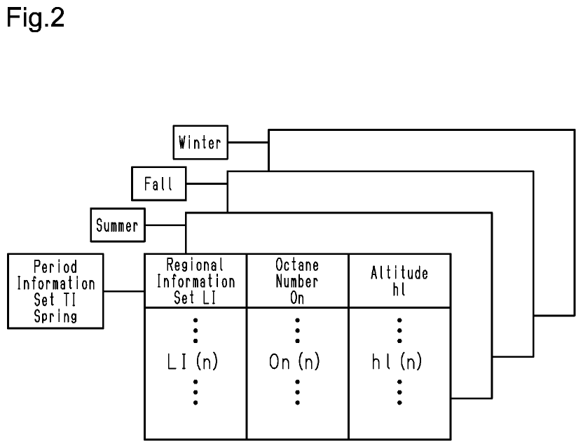

The controller 30 includes a memory device 36 that can be updated by being rewritten. The memory device 36 stores mapping data 36a for calculating specific parameters related to combustion of fuel. As shown in FIG. 2, the mapping data 36a includes four maps provided for respective period information sets TI. The period information sets TI are seasons. Spring, summer, fall, and winter are used as the period information sets TI.

An octane number On and an altitude hl corresponding to each of the regional information sets LI are used as specific parameters for each map. Regions having a certain range, such as countries, states, counties, prefectures, cities, towns, or villages are used as the regional information sets LI. The octane number of the fuel that is predicted to be used in a certain region is used as the octane number On. The average of the altitudes in the region of the corresponding regional information set LI is set as the altitude hl.

The mapping data 36a stores specific parameters corresponding to the period information sets TI and the regional information sets LI. In this example, the specific parameters are set for the respective seasons and regions.

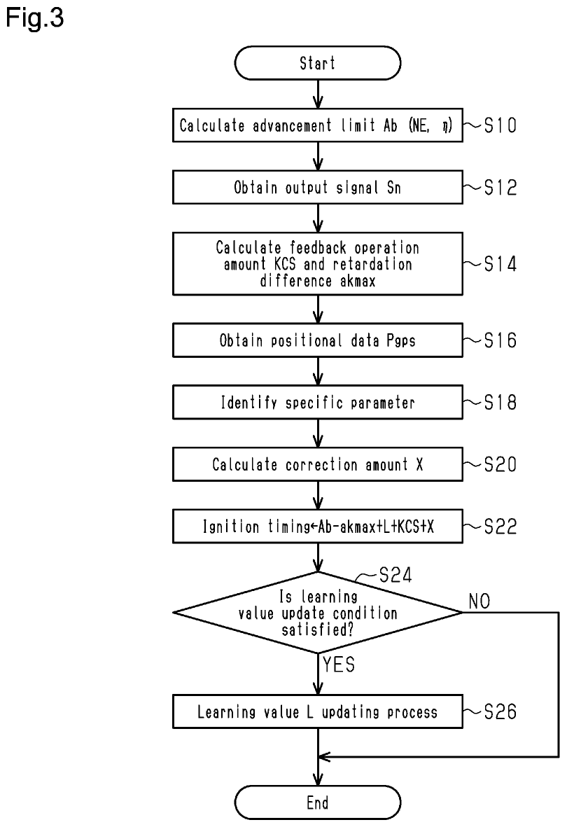

FIG. 3 shows a procedure of processes executed by the controller 30. The process shown in FIG. 3 is executed by the CPU 32 repeatedly executing control programs 34a stored in the ROM 34 at predetermined intervals. In the following description, the number of each step is represented by the letter S followed by a numeral.

In the series of processes shown in FIG. 3, the CPU 32 first calculates an advancement limit Ab on the basis of a rotation speed NE and a charging efficiency η (S10). The advancement limit Ab is the retarded one of the MBT ignition timing and a first knock limit point. The MBT ignition timing is the ignition timing at which the maximum torque is obtained (maximum torque ignition timing). The first knock limit point is the advancement limit of the ignition timing (knock limit point ignition timing) at which knocking can be kept within an allowable level under the assumed best conditions when a large-octane-number fuel, which has a large knock limit value, is used. The first knock limit point is the value when a fuel of the largest octane number On among the octane numbers On set in the mapping data 36a is used. The rotation speed NE is calculated by the CPU 32 on the basis of the output signal Scr. The charging efficiency η is calculated by the CPU 32 on the basis of the rotation speed NE and the intake air amount Ga.

Next, the CPU 32 obtains the output signal Sn of the knocking sensor 40 (S12). On the basis of the output signal Sn, the CPU 32 calculates a retardation difference akmax and a feedback operation amount KCS, which is an operation amount for advancing the ignition timing within a range in which knocking can be suppressed (S14). Specifically, if the vibration intensity based on the output signal Sn is greater than or equal to a predetermined value, the CPU 32 updates the feedback operation amount KCS by an update amount on the retarding side. The CPU 32 increases the absolute value of the update amount as the amount by which the vibration intensity exceeds the predetermined value increases. Also, if the vibration intensity is less than the predetermined value, the CPU 32 updates the feedback operation amount KCS to the advancing side by a predetermined update amount at a time.

An advancing-side upper limit and a retarding-side upper limit are set for the feedback operation amount KCS. The feedback operation amount KCS is a value within the range defined by the advancing-side upper limit and the retarding-side upper limit. The retardation difference akmax is the difference between the advancement limit Ab and a second knock limit point. The second knock limit point is the advancement limit of the ignition timing (knock limit point ignition timing) at which knocking can be kept within an allowable level when there is no deposit accumulation while a small-octane-number fuel, which has a small knock limit value, is used. The second knock limit point is the value when a fuel of the smallest octane number On among the octane numbers On set in the mapping data 36a is used. Specifically, the CPU 32 variably sets the retardation difference akmax on the basis of the rotation speed NE and the charging efficiency η.

The CPU 32 then obtains the positional data Pgps by the GPS 52 (S16). Next, by referring to the mapping data 36a, the CPU 32 identifies the octane number On and the altitude hl, which are specific parameters related to combustion of fuel, on the basis of the positional data Pgps representing the position of the vehicle VC and the date and time at which the positional data Pgps was obtained (S18).

Specifically, the CPU 32 determines the season that corresponds to the date and time at which the positional data Pgps was obtained in S16, that is, which of the four period information sets TI corresponds to the obtained date and time. For example, the CPU 32 determines that the obtained date and time at which the positional data Pgps was obtained in step S16 corresponds to spring if the date and time is in the period from March to May, summer if the date and time is in the period from June to August, fall if the date and time is in the period from September to November, and winter if the date and time is in the period from December to February. The CPU 32 selects the identified season as the period information set TI.

Further, the CPU 32 determines which region corresponds to the spot of the positional data Pgps obtained in S16. The CPU 32 selects the determined region as the regional information set LI. The CPU 32 then selects a map corresponding to the selected period information set TI and uses the selected map to identify the octane number On and the altitude hl that correspond to the selected regional information set LI. For example, if the selected period information set TI is spring, and the selected regional information set LI is a regional information set LI(n), the CPU 32 identifies, from the map for spring, an octane number On(n) as the octane number On corresponding to the regional information set LI(n) and identifies an altitude hl(n) as the altitude hl.

Next, the CPU 32 calculates a correction amount X on the basis of the specific parameters identified in S16 (S20). The correction amount X is calculated as a value greater than or equal to 0 and less than or equal to the retardation difference akmax. Specifically, the CPU 32 calculates a fuel correction amount using the octane number On identified in S18. The calculated value of the fuel correction amount is increased as the octane number On increases. Also, if the octane number On is the highest in the octane numbers used to calculate the first knock limit point, the same value as the retardation difference akmax is calculated as the fuel correction amount. On the other hand, the calculated value of the fuel correction amount is decreased as the octane number On decreases. Also, if the octane number On is the lowest in the octane numbers used to calculate the second knock limit point, the fuel correction amount is calculated as 0. The set value of the correction amount X is decreased as the altitude hl is increased. For example, an altitude coefficient that is greater than 0 and less than or equal to 1 is used. In this case, if the altitude hl is less than or equal to 0, the altitude coefficient is calculated to be 1, and the altitude coefficient is calculated to approach 0 as the altitude hl is increased. The correction amount X is calculated by multiplying, by the altitude coefficient, the fuel correction amount calculated using the octane number.

Next, the CPU 32 subtracts the retardation difference akmax from the advancement limit Ab, and adds, to the difference, the feedback operation amount KCS, the correction amount X, and a learning value L, which will be discussed below. The CPU 32 assigns the resultant to the ignition timing. The CPU 32 controls the ignition device 24 so that the ignition device 24 generates spark discharge at the calculated ignition timing (S22).

Next, the CPU 32 determines whether a learning value update condition is satisfied (S24). The learning value update condition includes the coolant temperature THW detected by the coolant temperature sensor 46 being higher than or equal to a predetermined temperature, and the rotation speed NE being higher than or equal to a predetermined speed.

If the learning value update condition is satisfied (S24: YES), the CPU 32 updates a learning value L (S26). The CPU 32 first updates a learning operation amount KCSs, which is an exponential moving average process value of the feedback operation amount KCS. Specifically, the CPU 32 updates the learning operation amount KCSs to KCSs+β·(KCS−KCSs) by using a value β, which is greater than 0 and less than 1. When the learning operation amount KCSs is more advanced than an advancement reference value, the CPU 32 calculates, as an update reference amount Δ, a value obtained by subtracting the advancement reference value from the learning operation amount KCSs. The CPU 32 adds the update reference amount Δ to the learning value L in order to update the learning value L. When the learning operation amount KCSs is more retarded than a retardation reference value, the CPU 32 calculates, as the update reference amount Δ, a value obtained by subtracting the retardation reference value from the learning operation amount KCSs. The CPU 32 adds the update reference amount Δ to the learning value L in order to update the learning value L. Through these processes, the learning value L is updated such that the absolute value of the feedback operation amount KCS decreases. When the learning value L is updated, the update reference amount Δ is preferably subtracted from the learning operation amount KCSs or the feedback operation amount KCS.

When completing the process of S26 or when making a negative determination in the process of S24, the CPU 32 temporarily suspends the series of processes shown in FIG. 3.

The operation and advantages of the ignition timing controller for an internal combustion engine according to the present embodiment will now be described.

(1) The internal combustion engine 10 uses gasoline as the fuel. The octane numbers On of gasolines for sale vary depending on the country, state, and the like. Thus, it is possible to improve fuel combustion by using, in the calculation of ignition timing, differences in the octane numbers On of different regions in which the vehicles VC are used. In this respect, the CPU 32 of the above-described embodiment selects the regional information set LI corresponding to the region in which the vehicle VC is located from the positional data Pgps of the vehicle VC, and calculates the correction amount X on the basis of the octane number On, which is a specific parameter corresponding to the selected regional information set LI. The CPU 32 then calculates the ignition timing on the basis of the correction amount X and controls the ignition device 24. The CPU 32 is thus capable of calculating the ignition timing while reflecting the difference in the octane number On among regions on the ignition timing. That is, in the above-described configuration, the ignition device is controlled on the basis of the specific parameter corresponding to the positional information of the vehicle. Thus, differences in the specific parameter depending on the area in which the vehicle is used are reflected on the control of the ignition device. In this example, a required ignition timing is set on the basis of differences in the property of fuel among regions in which the vehicle is used. Thus, an appropriate required ignition timing can be set in accordance with the differences in the property of the fuel.

(2) The amount of oxygen in a fixed volume of air decreases as the atmospheric pressure lowers. Accordingly, the lower the atmospheric pressure, the less easily the fuel is burned in the combustion chamber 22. The atmospheric pressure significantly varies mainly depending on the altitude. In the above-described embodiment, the altitude hl in the regional information set LI where the vehicle V is located is identified, and the ignition timing is calculated while reflecting the difference in the altitude hl among regions on the ignition timing. That is, in the above-described configuration, the required ignition timing is set on the basis of differences in the altitude at which the vehicle is used. Thus, an appropriate required ignition timing can be set in accordance with the differences in the air density at each altitude.

(3) The property of fuel can change with seasons. For example, in summer, when the air temperature is high, fuel tends to be atomized and vaporized due to the high volatility and is easy to burn. In the above-described embodiment, the specific parameter in the regional information set LI where the vehicle VC is located is identified by selecting a map set for each period information set TI. Therefore, even if the property of the fuel is different between summer and winter, the ignition device 24 can be controlled while reflecting the seasonal differences of the fuel property on the ignition timing. That is, the above-described configuration allows the specific parameter that corresponds to the period information to be identified even if the specific parameter that corresponds to the positional information varies according to the season.

(4) Since the memory device 36 is mounted on the vehicle VC, communication with the outside is not necessary. Accordingly, relatively small number of processes are required for the controller to perform the above-described technique.

### Second Embodiment

A second embodiment will now be described with reference to the drawings. The differences from the first embodiment will mainly be discussed.

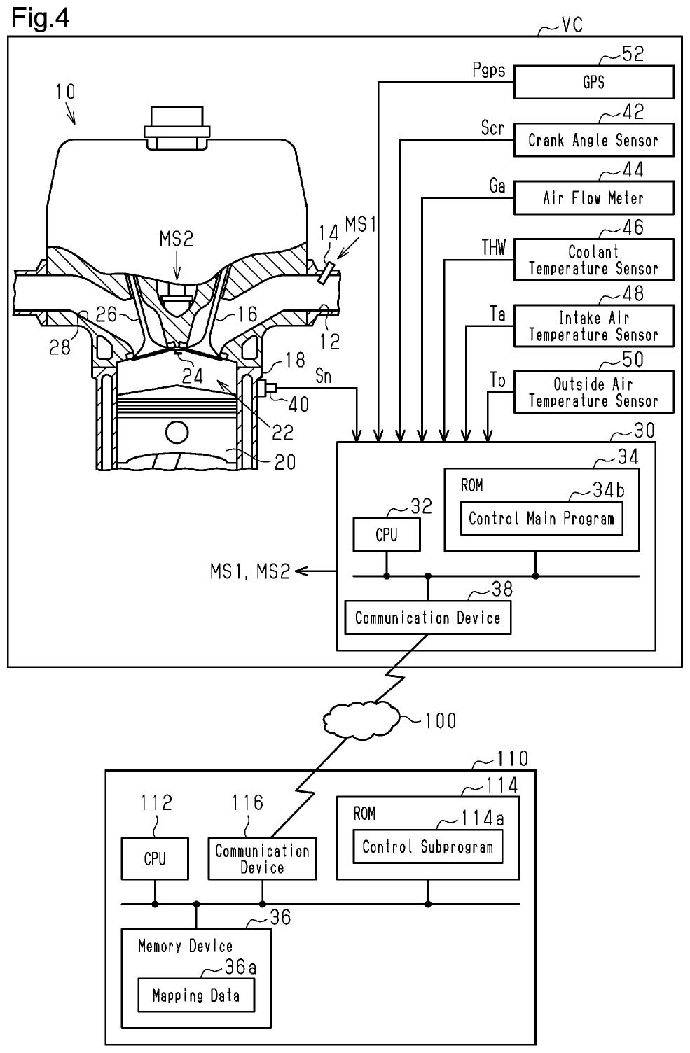

FIG. 4 shows the configuration of an ignition timing control system for an internal combustion engine according to a second embodiment. In FIG. 4, the same reference numerals are given to the components that are the same as those in FIG. 1 for illustrative purposes.

As shown in FIG. 4, the vehicle VC includes the ROM 34, which stores a control main program 34b. The controller 30 includes a communication device 38. The communication device 38 communicates with a server 110 via a network 100 outside the vehicle VC. The vehicle VC does not include the memory device 36 and thus does not store data indicating specific parameters.

The server 110 includes a CPU 112 and a ROM 114. The CPU 112 of the server 110 repeatedly executes a control sub-program 114a stored in the ROM 114 at predetermined intervals. The server 110 includes the memory device 36. That is, in the second embodiment, the server 110 outside the vehicle VC includes the memory device 36, which stores the specific parameters. The server 110 also includes a communication device 116. The communication device 116 communicates with the controller 30 of the vehicle VC via the network 100 outside the server 110.

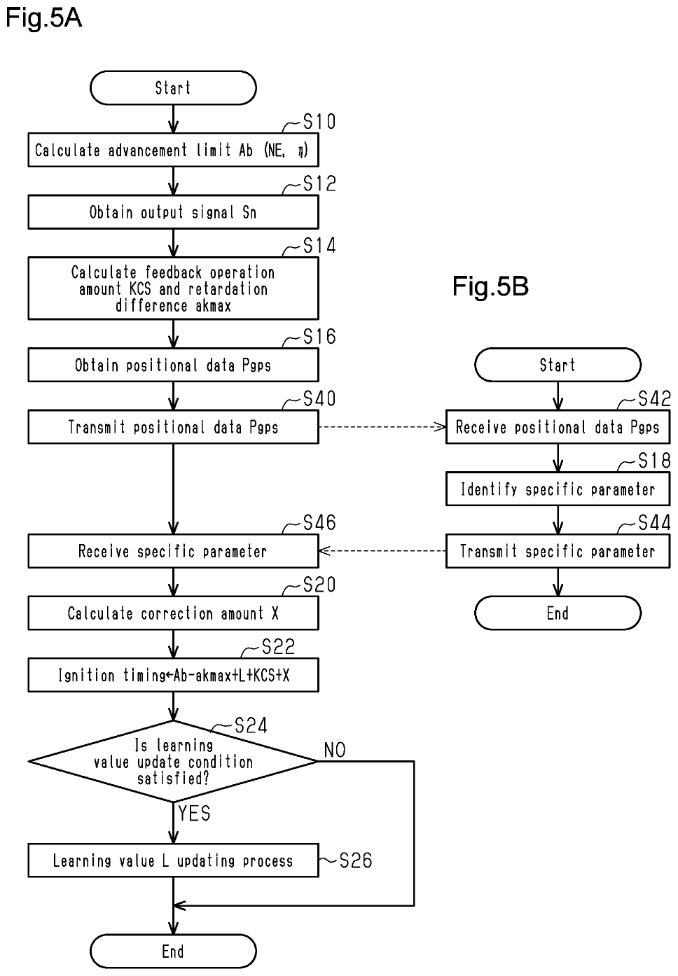

FIGS. 5A and 5B show a procedure of processes of an ignition timing control for an internal combustion engine according to the present embodiment. The processes shown in FIG. 5A are implemented by the CPU 32 executing the control main program 34b stored in the ROM 34 shown in FIG. 4. The processes shown in FIG. 5B are implemented by the CPU 112 executing the control subprogram 114a stored in the ROM 114 shown in FIG. 4. In FIGS. 5A and 5B, the same step numbers are given to the steps that are the same as those in processes of FIG. 3, explanations for those steps are either simplified or omitted. The processes shown in FIGS. 5A and 5B will now be described according to the temporal sequence.

In the series of processes shown in FIG. 5A, the CPU 32 executes the processes of S10, S12, S14, and S16. Next, the CPU 32 operates the communication device 38, which sends, to the server 110, a signal indicating the positional data Pgps obtained in S16 and the date and time at which the positional data Pgps was obtained (S40).

In response to this, the CPU 112 of the server 110 receives the signal indicating the positional data Pgps and the date and time at which the positional data Pgps was obtained (S42) as shown in FIG. 5B. The CPU 112 determines which region corresponds to the spot of the positional data Pgps received in S42. The CPU 112 selects the determined region as the regional information set LI. Also, the CPU 112 determines the season that corresponds to the date and time at which the positional data Pgps was obtained in S42. The CPU 32 selects the identified season as the period information set TI. Next, the CPU 112 executes the process of S18. The CPU 112 sends, to the vehicle VC, a signal indicating the specific parameter identified in the process of S18 (S44). When the process of step S44 is completed, the CPU 112 temporarily suspends the series of processes shown in FIG. 5B.

In response to this, the CPU 32 receives the signal indicating the specific parameter as shown in FIG. 5A (S46). Next, the CPU 32 executes the processes of S20 to S26. When completing the process of S26 or when making a negative determination in the process of S24, the CPU 32 temporarily suspends the series of processes shown in FIG. 5B.

The operation and advantages of the ignition timing control system for an internal combustion engine according to the present embodiment will now be described. The second embodiment has the following advantages.

(5) The CPU 112 selects the regional information set LI corresponding to the region in which the vehicle VC is located from the positional data Pgps of the vehicle VC. Then, the CPU 32 calculates the correction amount X on the basis of the octane number On, which is the specific parameter that corresponds to the regional information set LI corresponding to the region in which the vehicle VC is located. The CPU 32 then calculates the ignition timing on the basis of the correction amount X and controls the ignition device 24. The CPU 32 is thus capable of controlling the ignition device 24 while reflecting, on the ignition timing, the differences among the regional information sets LI corresponding to regions in which the vehicle VC is located. That is, in the above-described configuration, the required ignition timing in the internal combustion engine of a vehicle is set on the basis of the specific parameter that corresponds to the positional information of the vehicle. Thus, differences in the positional information of the vehicle are reflected on the setting of the required ignition timing.

(6) In order to manage the mapping data 36a, it suffices if only the mapping data 36a stored in the server 110 is managed. Data management is thus easy as compared to a case in which respective vehicles store the mapping data 36a.

### Correspondence

The correspondence between the items in the above-described embodiments and the items the WHAT IS CLAIMED IS section is as follows. The correspondence of respective claim numbers with the above-described embodiments will be explained below.

[1] The execution device corresponds to the CPU 32 and the ROM 34, and the memory device corresponds to the memory device 36. The positional information obtaining process corresponds to the processes of S16, the identifying process corresponds to the process of S18, and the operation process corresponds to the process of S22. The positional information corresponds to the positional data Pgps.

[2] The value indicating the property of fuel corresponds to the octane number On.

[3] The value indicating the altitude corresponds to the altitude hl.

[4] The period information set corresponds to the period information set TI.

[5] The in-vehicle device corresponds to the controller 30, the out-of-vehicle device corresponds to the server 110. The memory device corresponds to the memory device 36, and the out-of-vehicle execution device corresponds to the CPU 112. The positional information obtaining process corresponds to the processes of S16, the first transmitting process corresponds to the process of S40, the first receiving process corresponds to S42, the identifying process corresponds to the process of S18, the second transmitting process corresponds to the process of S44, the second receiving process corresponds to the process of S46, and the operation process corresponds to the process of S22.

### Other Embodiments

The above-described embodiments may be modified as follows. The above-described embodiments and the following modifications can be combined as long as the combined modifications remain technically consistent with each other.

The setting of the ignition timing is not limited to the one that is exemplified by the process of S22. For example, the retardation difference akmax and the advancement limit Ab do not necessarily need to be used. Also, parameters referred to by the controller 30 may be fed to a neural network, and the ignition timing may be calculated on the basis of an output of the neural network.

The learning value L is not limited to the one including a single learning value, but may be the sum of multiple learning values, for example, the sum of a first learning value, a second learning value, and a third learning value. In this case, the number of learning values to be used may be changed. For example, in a region in which the charging efficiency η is large, the first learning value may be used as the learning value L. Also, in a region in which the charging efficiency η is small, the sum of the first learning value, the second learning value, and the third learning value may be used as the learning value L. Further, the learning value may be updated for each of divided regions, and the learning values may correspond to different regions. For example, the first learning value may be learned for each of the regions divided according to the rotation speed NE, and the second learning value and the third learning value may be learned for each of the regions divided according to the rotation speed NE and the charging efficiency η.

The method in which the learning value L is updated is not limited to the ones described in the above-described embodiments. For example, the ignition timing may be adjusted by updating a reward through reinforcement learning. In this case, the reward simply needs to be updated by being increased when knocking is not occurring, and being reduced when knocking is occurring.

The specific parameters are not limited to the octane numbers On and the altitudes hl, which are used in the above-described embodiments. For example, whether the fuel contains additives and the amounts of such additives may be used as values indicating the property of the fuel. Also, ethanol concentration may be used as a value indicating the property of the fuel when an ethanol-blended fuel is used as the fuel for the internal combustion engine 10.

Parameters other than the property of the fuel and the altitudes hl may be used as the specific parameters. For example, the combustion state of fuel can be affected by deterioration of the components of the internal combustion engine 10. Therefore, the travelled distance of the vehicle VC may be used as a specific parameter related to combustion of the fuel.

In the above-described embodiments, the altitude hl does not necessarily need to be set to the average of altitudes in a region. For example, the value indicating the altitude may be broadly categorized into, for example, lowland, middle land, and highland.

In the above-described embodiments, the octane number On may be set to a specific value. Alternatively, the octane number On may be roughly categorized into, for example, a low octane number fuel and a high octane number fuel.

In the above-described embodiments, two parameters, or the octane number On and the altitude hl, are used as the specific parameters. However, only one of these may be used. Alternatively, other parameters may be employed in addition to the two parameters.

The period information sets TI are not limited to those in the above-described embodiments. For example, the period information sets TI may be divided according to the month or divided into a dry season and a rainy season. Alternatively, the period information sets TI may be omitted, and the mapping data 36a may include a single map that is used throughout the year.

In the above-described embodiments, the mapping data 36a may be updated periodically. In the second embodiment, the mapping data 36a is located outside the vehicle VC. This configuration is favorable since the mapping data 36a does not need to be updated for each of the vehicles VC.

The configuration of the mapping data 36a is not limited to those described in the above-described embodiments. For example, maps each corresponding to one of the four seasons do not necessarily need to be used. Multiple maps may be prepared for each of the regional information sets LI, and specific parameters corresponding to each season may be set for each map. Also, specific parameters that correspond to the regional information sets LI and the period information sets TI may be set by a single map.

In the second embodiment, the ignition timing control system for an internal combustion engine is not limited to the one including the controller 30 and the server 110. For example, the ignition timing control system for an internal combustion engine may include a portable terminal carried by a user in place of the server 110, so that the ignition timing control system includes the controller 30 and the portable terminal. Also, the ignition timing control system for an internal combustion engine may include a portable terminal carried by a user in place of the communication device 38, so that the ignition timing control system includes the controller 30, the portable terminal, and the server 110.

In the above-described embodiments, the execution device is not limited to a device that includes the CPU 32 and the ROM 34 and executes software processing. For example, at least part of the processes executed by the software in the above-described embodiment may be executed by hardware circuits dedicated to executing these processes (such as an application-specific integrated circuit (ASIC)). That is, the execution device may be modified as long as it has any one of the following configurations (a) to (c). (a) A configuration including a processor that executes all of the above-described processes according to programs and a program storage device such as a ROM that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. Multiple software processing devices each including a processor and a program storage device and multiple dedicated hardware circuits may be provided. Such modification is also applicable to the out-of-vehicle execution device.

In the above-described embodiments, the memory device 36 is separate from the ROM 34 or the ROM 114. However, the present disclosure is not limited to this. The ROM 34 and the ROM 114 may function as memory devices. In this case, the device that stores the mapping data 36a serves as the memory device.

In the above-described embodiment, the internal combustion engine 10 does not necessarily need to include, as the fuel injection valve, a port injection valve that injects fuel to the intake passage 12, but may include a direct injection valve that injects fuel into the combustion chamber 22. Further, the internal combustion engine 10 may include a port injection valve and a direct injection valve.

In the above-described embodiments, the internal combustion engine 10 is not limited to a spark-ignition engine, but may be a compression ignition engine that uses, for example, light oil or the like.

In the above-described embodiments, the vehicle VC is not limited to a vehicle that includes only an internal combustion engine as a propelling force generator, but may be a hybrid vehicle that includes an internal combustion engine and a rotating electric machine.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An ignition timing controller for an internal combustion engine, comprising:
an execution device; and
a memory device, wherein
the memory device is configured to store specific parameters related to combustion of a fuel in association with positional information,
the execution device is configured to execute:
a positional information obtaining process that obtains positional information of a vehicle,
an identifying process that identifies, among the specific parameters stored in the memory device, a specific parameter that corresponds to the obtained positional information, and
an operation process that controls an ignition device of the internal combustion engine of the vehicle on a basis of the specific parameter identified by the identifying process.

2. The ignition timing controller for an internal combustion engine according to claim 1, wherein the specific parameters include a value indicating a property of the fuel.

3. The ignition timing controller for an internal combustion engine according to claim 1, wherein the specific parameters include a value indicating an altitude.

4. The ignition timing controller for an internal combustion engine according to claim 1, wherein
the memory device is configured to store the specific parameters in association with period information in addition to the positional information,
the positional information obtaining process includes a process that obtains, together with the positional information, period information of a time when the positional information was generated, and
the identifying process includes a process that identifies the specific parameter that corresponds to the positional information and the period information.

5. An ignition timing controller for an internal combustion engine, comprising:
an execution device; and
a memory device, wherein
the memory device is configured to store specific parameters related to combustion of a fuel in association with positional information,
the execution device includes circuitry, the circuitry being configured to execute:
a positional information obtaining process that obtains positional information of a vehicle,
an identifying process that identifies, among the specific parameters stored in the memory device, a specific parameter that corresponds to the obtained positional information, and
an operation process that controls an ignition device of the internal combustion engine of the vehicle on a basis of the specific parameter identified by the identifying process.

6. An ignition timing control method for an internal combustion engine, comprising:
storing specific parameters related to combustion of a fuel in association with positional information;
obtaining positional information of a vehicle;
identifying, among the specific parameters stored in the memory device, a specific parameter that corresponds to the obtained positional information; and
controlling an ignition device of the internal combustion engine of the vehicle on a basis of the identified specific parameter.

7. An ignition timing control system for an internal combustion engine, comprising:
an in-vehicle device mounted on a vehicle; and
out-of-vehicle device that is provided outside the vehicle, wherein
the out-of-vehicle device includes a memory device and an out-of-vehicle execution device,
the memory device is configured to store specific parameters related to combustion of a fuel in association with positional information,
the in-vehicle device is configured to execute:
a positional information obtaining process that obtains positional information of the vehicle, and
a first transmitting process that transmits a signal indicating the positional information obtained by the positional information obtaining process, the out-of-vehicle execution device is configured to execute:
a first receiving process that receives the signal indicating the positional information transmitted by the first transmitting process,
an identifying process that identifies, among the specific parameters stored in the memory device, a specific parameter that corresponds to the positional information received by the first receiving process, and
a second transmitting process that transmits a signal indicating the specific parameter identified by the identifying process, and
the in-vehicle device is configured to further execute:
a second receiving process that receives a signal indicating the specific parameter transmitted by the second transmitting process, and
an operation process that performs an ignition operation of an ignition device of the internal combustion engine of the vehicle on a basis of the specific parameter received by the second receiving process.
